(19) United States
(12) Patent Application Publication
(10) Pub. No.: US 2009/0135013 A1
(43) Pub. Date: May 28, 2009

(54) ARTICLE MANAGEMENT SYSTEM AND INFORMATION PROCESSING APPARATUS

(75) Inventors: Hiroyuki KUSHIDA, Kanagawa (JP); Shinji SAEGUSA, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: TOSHIBA TEC KABUSHIKI KAISHA, Tokyo (JP)

(21) Appl. No.: 12/323,938

(22) Filed: Nov. 26, 2008

(30) Foreign Application Priority Data
Nov. 27, 2007 (JP) 2007-305327

(51) Int. Cl. G08B 21/00

(52) U.S. Cl. 340/568.1; 382/103

(57) ABSTRACT

An article management system is provided with an article placement position storage section which stores article identification information of a plurality of articles and article position information showing a section on which the plurality of articles is placed in association with each other, an object detection section which measures a position of an object positioned inside the section or outside the section to output object position information, and an article specification section which compares object position information detected by the object position detection section and the article position information with each other and, when the object position information is included in section where the article is placed, shown by the article position information, specifies the article identification information stored in association with the article position information.

### CROSS-REFERENCE TO RELATED APPLICATIONS

This application is based upon and claims the benefit of priority from prior Japanese Patent Application No. 2007-305327, filed Nov. 27, 2007, the entire contents of which are incorporated herein by reference.

### BACKGROUND OF THE INVENTION

1. Field of the Invention

The present invention relates to an article management system which manages an article which is displayed or stored on a shelf or a stand, such as an item of merchandise or a sample and an information processing apparatus.

2. Description of the Related Art

In recent years, competition between shops such as retail outlets has becomes fierce. Therefore, it has become an important factor in marketing to examine and determine which merchandise appeals to customers to achieve differentiation from other shops. For example, it is an important factor to examine attention of customers to merchandise displayed in a shop, examine an effect of shelving allocation which is a merchandise layout of a merchandise display shelf on which merchandise is displayed, or the like.

Jpn. Pat. Appln. KOKAI Publication No. 10-048008 discloses a technique of installing a television camera on a ceiling, a wall, or the like about merchandise to be examined to set a merchandise display shelf, a show case, or the like as an object to be measured, and photograph images of customers, thereby obtaining attention of customers to merchandise. However, such a technique utilizing images is reduced in measurement range. The technique has such a problem that the television camera is easily subject to optical influence such as illumination or a shade of a shelf, a pillar, or the like, installation of a camera on a ceiling or a wall, de-installation work, and maintenance become large-scale, and an installation place of the camera is restricted.

In-the technique disclosed in this publication, when a period where a customer stays in a measurement range in a shop exceeds a fixed time range, it is determined that the customer has paid attention to an merchandise on a display shelf present in the measurement range. Therefore, when the number of kinds of merchandise displayed on the merchandise display shelf is one, the attention can be measured. In an actual shop, however, there is such an actual status that a plurality of kinds of merchandise is displayed on a merchandise display shelf bit by bit, so that it is difficult to designate and tally merchandise to which customers have paid attention more accurately in the technique disclosed in the publication.

It is possible to examine merchandise which customers have paid attention to and have purchased at this time by analyzing merchandise sales data managed by a point-of-sales (POS) system. However, it is impossible to specify merchandise which has been once picked up from a merchandise display shelf by a customer but has been returned to the display shelf thereby or perform analysis such as comparison between the number of times where customers have actually picked up merchandise and the quantity sold of merchandise identical with the merchandise from the merchandise sales data of the POS system. These information items are information about merchandise to which customers have paid attention but which has not been purchased or merchandise which does not show an increase in the quantity sold thereof as compared with attention thereto, and they are important factors for marketing strategy at the shop.

### BRIEF SUMMARY OF THE INVENTION

An object of the present invention is to provide an article management system and an information processing apparatus where attention of customers to an article displayed on a shelf or a stand, such as merchandise or a sample can be examined in depth.

In order to achieve the object, according to an aspect of the present invention, there is provided an article management system comprising: an article placement position storage section which stores article identification information about a plurality of articles and article position information showing a section on which the articles are placed in association with each other; an object detection section which measures an object positioned inside the section or outside the section to output object position information; and an article specification section which compares the object position information detected by the object detection section and the article position information with each other and, when the object position information is included within the section shown by the article position information, specifies an article relating to the article identification information stored in association with the article position information.

According to the present invention, it is possible to provide an article management system and an information processing apparatus where attention of customers to an article displayed on a shelf or a stand, such as merchandise or a sample can be examined in depth.

### BRIEF DESCRIPTION OF THE SEVERAL VIEWS OF THE DRAWING

FIG. 1 is a diagram showing a system configuration according to a first embodiment of the present invention;

FIG. 2 is a diagram showing a hardware configuration of a system according to the first embodiment;

FIG. 3 is a diagram showing a configuration of a sensor section according to the first embodiment;

FIG. 4 is a diagram showing a configuration of the sensor section and a merchandise display shelf according to the first embodiment;

FIG. 5 is a diagram showing a configuration of the sensor section and the merchandise display shelf according to the first embodiment;

FIG. 6 is a diagram showing a data structure of a position data table according to the first embodiment;

FIG. 7 is a diagram showing a data structure of an effective region table according to the first embodiment;

FIG. 8 is a diagram showing a data structure of a shelving allocation table according to the first embodiment;

FIG. 9 is a diagram showing a data structure of a position specification table according to the first embodiment;

FIG. 10 is a diagram showing a data structure of an article specification table according to the first embodiment;

FIG. 11 is a flowchart showing a processing procedure of an article management system according to the first embodiment;

FIG. 12 is a flowchart showing a processing procedure of effective information extraction processing according to the first embodiment;

FIG. 13 is a flowchart showing a processing procedure of position specification processing according to the first embodiment;

FIG. 14 is a flowchart showing a processing procedure of article specification processing according to the first embodiment;

FIG. 15 is a diagram showing a system configuration according to a second embodiment of the present invention;

FIG. 16 is a diagram showing a hardware configuration of a system according to the second embodiment;

FIG. 17 is a diagram showing a configuration of a sensor section according to the second embodiment;

FIG. 18 is a diagram showing a configuration of the sensor section and a merchandise display shelf according to the second embodiment;

FIG. 19 is a diagram showing a configuration of the sensor section and the merchandise display shelf according to the second embodiment;

FIG. 20 is a diagram showing a configuration of the sensor section and the merchandise display shelf according to the second embodiment;

FIG. 21 is a diagram showing a configuration of the sensor section and the merchandise display shelf according to the second embodiment;

FIG. 22 is a diagram showing a data structure of a position data table according to the second embodiment;

FIG. 23 is a diagram showing a data structure of an effective region table according to the second embodiment;

FIG. 24 is a diagram showing a data structure of a shelving allocation table according to the second embodiment;

FIG. 25 is a diagram showing a data structure of a position specification table according to the second embodiment;

FIG. 26 is a diagram showing a data structure of an article specification table according to the second embodiment;

FIG. 27 is a flowchart showing a processing procedure of an article management system according to the second embodiment;

FIG. 28 is a flowchart showing a processing procedure of effective information extraction processing according to the second embodiment;

FIG. 29 is a flowchart showing a processing procedure of position specification processing according to the second embodiment; and

FIG. 30 is a flowchart showing a processing procedure of article specification processing according to the second embodiment.

### DETAILED DESCRIPTION OF THE INVENTION

A best mode for carrying out the present invention will be explained below with reference to the drawings.

### First Embodiment

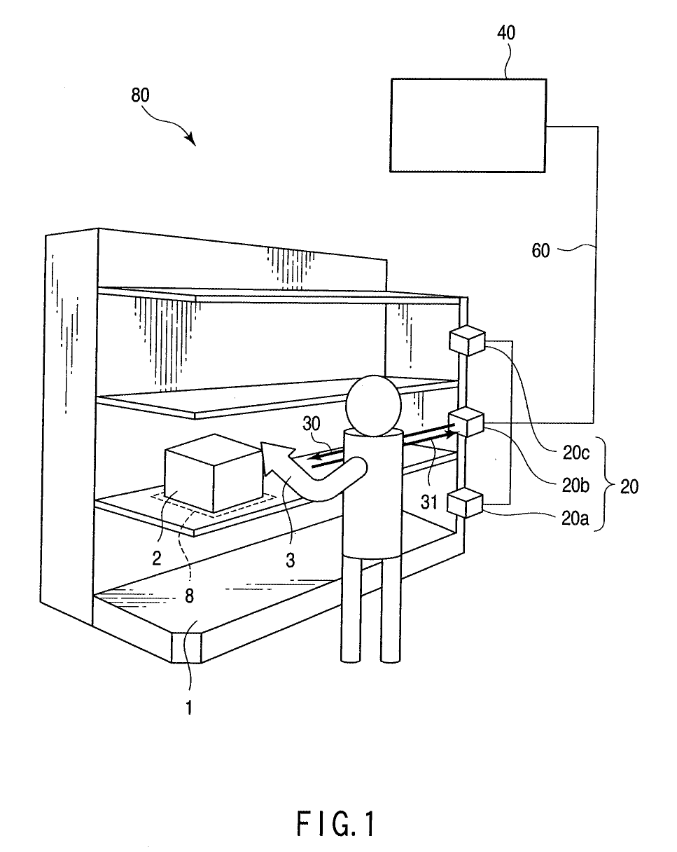

A first embodiment of the present invention will be explained with reference to FIGS. 1 to 14.

FIG. 1 is a diagram showing a configuration of an article management system 80 according to a first embodiment of the present invention. The article management system 80 comprises a sensor section 20 (an object detection section) and a system management section 40 (information processing apparatus).

The sensor section 20 comprises a sensor sections 20a, 20b, and 20c disposed corresponding to, for example, respective selves of a merchandise display shelf set 1 (placement part) in a shop, and when each sensor section detects an object 3 approaching an item of merchandise 2 (article) displayed on the merchandise display rack 1 or a merchandise display place 8 (article placement region), a distance from each sensor section to the object 3 is measured to be transmitted to the system management section 40 as position data (object position information) of the object 3. It should be noted that since the sensor sections 20a, 20b, and 20c have the same hardware configuration and the same function, explanation about the sensor section 20b will be made and explanation about the sensor sections 20a and 20b is omitted in the first embodiment.

In the embodiment, the sensor section 20b measures a distance up to the object 3 utilizing projection light 30 comprising infrared laser light. For example, projection light 30 comprising infrared laser light as infrared ray with a wavelength in a range from about 0.7 μm to 0.1 mm is projected, for example, from the sensor section 20b to the object 3 and reflected light 31 reflected from the object 3 is detected by the sensor section 20b, so that a distance up to the object 3 is measured based upon a time difference between a projection time of the projection light 30 and a detection time of the reflected light 31.

It should be noted that in the embodiment, the sensor section 20b measures the distance up to the object 3 utilizing projection light 30 comprising infrared laser light, but a method where the sensor section 20b measures distance is not limited to this method, and, for example, a configuration can be adopted wherein an ultrasonic wave, which is an acoustic wave with a frequency of about 20 kHz or more, is projected and a reflected wave thereof is detected so that the distance to the object 3 is measured from the projection time of the ultrasonic wave and the detection time of the reflected wave, as with the infrared laser light.

The object 3 to be detected is not limited to a clerk in a shop, a hand or an arm of a customer, or merchandise, and includes a robot arm of a service robot or the like performing shopping supporting service at a shop.

The system management section 40 is connected to the sensor section 20 via a communication line 60 such as an LAN or a dedicated line, and it receives position data of the object 3 transmitted and output from each of the sensor sections 20a to 20c to perform a processing based upon the received position data.

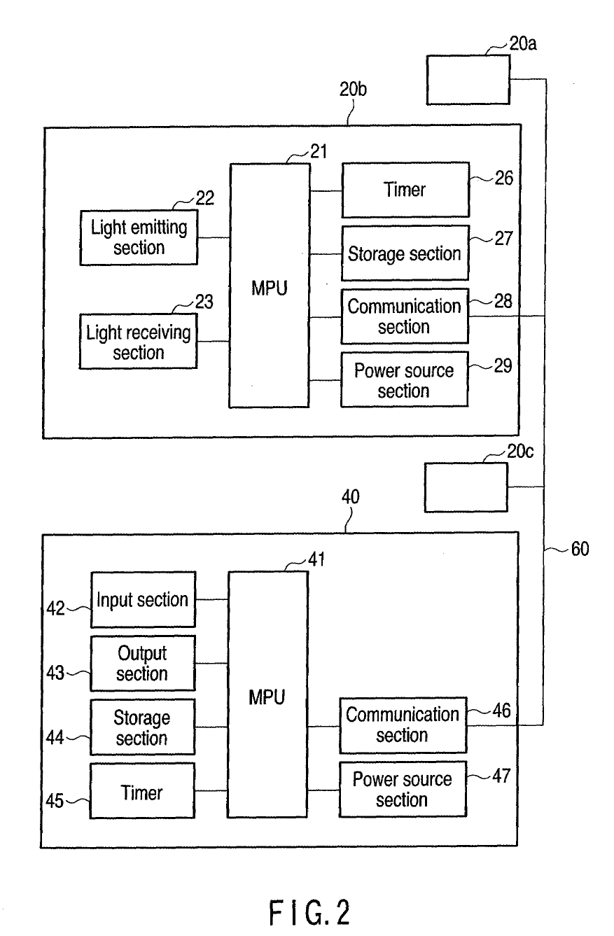

FIG. 2 is a diagram showing a hardware configuration of the article management system 80. The sensor section 20b comprises a microprocessing unit (MPU) 21 which configures a control section performing control of each hardware of the sensor section 20b, a light emitting section 22 (projection section) which emits projection light for detecting an object, a light receiving section 23 (detection section) which detects reflected light from the object, a timer section 26, a storage section 27 such as a hard disk or a memory, a communication section 28 which performs transmission and reception of data between the system management section 40 and the same, a power source section 29, and the like. Functions of respective sections of the sensor section 20b will be explained later.

The system management section 40 comprises a microprocessing unit (MPU) 41 which configures a control section performing control of each hardware of the system management section 40, an input section 42 such as a keyboard or a mouse, an output section 43 such as a display device such as a liquid crystal display or an organic EL display, or a printer, a storage section 44 such as a hard disk or a memory, a timer section 45, a communication section 46 which performs transmission and reception of data between the sensor section 20 or the other system and the same, a power source section 47, and the like. A position data table 100, an effective region table 110, a shelving allocation table 120, a position specification table 130, and an article specification table 140 are provided in the storage section 44. These tables will be explained later with reference to FIGS. 6 to 10.

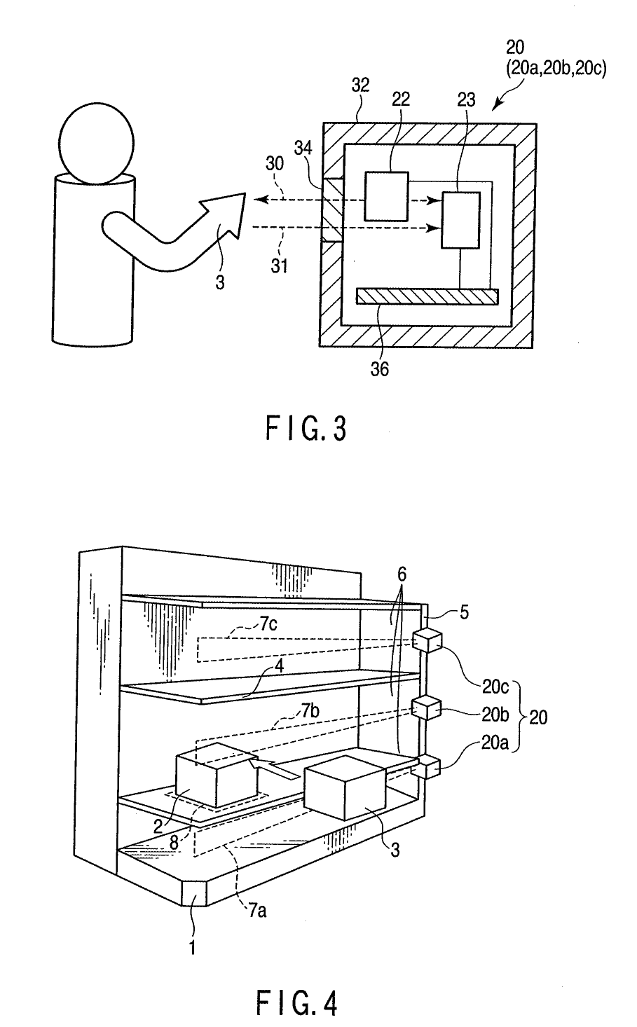

The sensor section 20 functioning as an object detection section of the article management system 80 will be explained with reference to FIGS. 3 to 5.

FIG. 3 is a diagram showing a configuration of the sensor section 20b. The sensor section 20b comprises a light emitting section 22 (projection section), a light receiving section 23 (detection section), a casing 32, a sensor control section 36, and the like. The casing 32 is formed, for example, in a cylindrical shape, and it is provided with an annular transparent window 34 opened over a range of 180° along a circumferential direction. The light emitting section 22 comprises, for example, a light source such as an infrared laser or an LED, and the light receiving section 23 comprises, for example, an optical sensor such as a photodiode.

The sensor control section 36 functions as an object position calculation section. As shown in FIG. 2, the sensor control section 36 comprises an MPU 21, a timer 26, a storage section 27, a communication section 28, a power source section 29, and the like, and it performs emission control of the light emitting section 22 and measures and calculates a distance from the sensor section 20b to the object 3.

As a method for calculating a distance utilizing the projected light 30 and the reflected light 31, for example, there is a method of emitting infrared laser light emitted from the light emitting section 22 as short pulse-like projection light 30, detecting the reflected light 31 at the light receiving section 23, and obtaining a distance from a time difference between a time at which the projection light 30 has been emitted and a time at which the reflected light has been detected, a reciprocating time from projection to detection of the light, and velocities of the projection light 30 serving as reference and the reflected light 31, or a method of modulating infrared laser light emitted from the light emitting section 22 using a sine wave having a fixed frequency to obtain a distance from a phase difference between the projection light 30 and the reflected light 31. In the method for obtaining a distance from a phase difference, since a distance showing a phase difference greater than or equal to one cycle cannot be measured, it is necessary to determine a frequency modulating from a predetermined detection region. In the embodiment, the sensor section 20b measures distance to the object 3 utilizing the projection light 30 comprising infrared laser light, but the distance to the object 3 may be measured from the time at which ultrasonic wave is projected and the time at which reflected wave of the ultrasonic wave is detected by projecting the ultrasonic wave to detect the reflected wave, as with the infrared laser light.

The sensor control section 36 calculates a distance from the sensor section 20b to the object 3 from a time difference between a time of emission of the projection light emitted from the light emitting section 22 and a time of detection of the reflected light 31 received by the light receiving section 23 using the abovementioned method to transmit position data comprising the calculated distance data and sensor identification data identifying the sensor section 20b to the system management section 40. When the system management section 40 receives the position data from the sensor section 20b, it determines which sensor section (20a, 20b, or 20c) has transmitted the position data to acquire position information of the object 3.

FIG. 4 is a diagram showing a state that the sensor section 20 comprising the sensor sections 20a to 20c is installed on the merchandise display rack 1 (placement part). Each sensor section detects the object 3 approaching merchandise 2 (article) displayed on the merchandise display rack 1 or the merchandise display place 8 (article placement region) of the merchandise 2. The sensor section 20 is installed, for example, at a side part of a shelf peripheral part 5 on a shelf front 4 side where opened merchandise take-out and put-back regions 6 (opening) of the merchandise display rack 1 are present.

Projection lights 30 with a width are emitted laterally from the sensor sections 20a to 20c and detection regions 7a, 7b, and 7c serving as a reference for detecting the object 3 are formed on a front of the merchandise take-out and put-back regions 6 in a strip-shaped so as to cover the front.

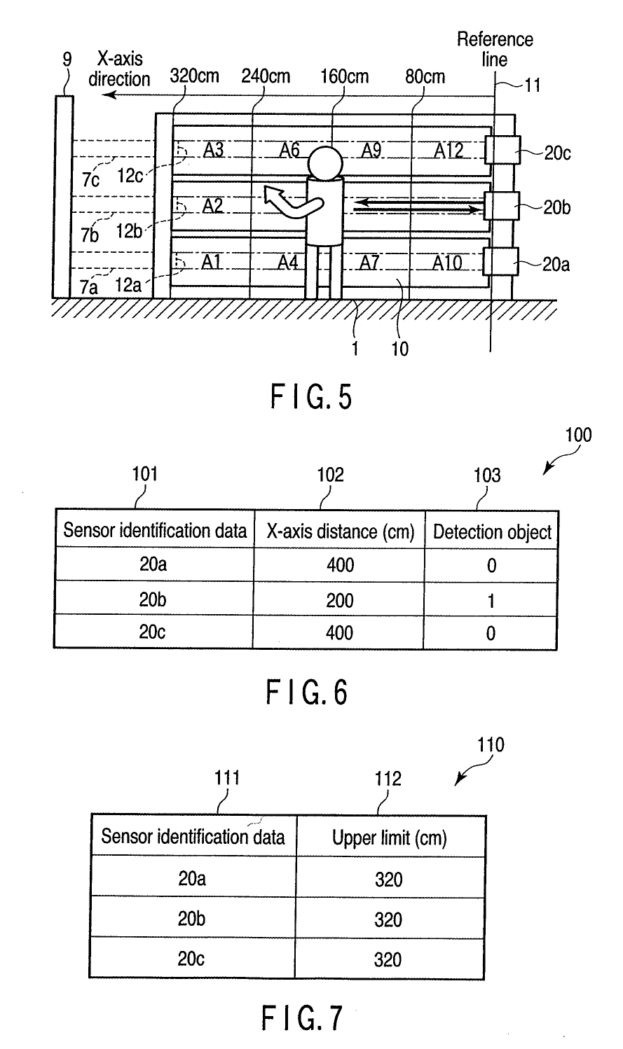

FIG. 5 is a diagram showing a state that the merchandise display rack 1 is divided to blocks 10 (sections) from A1 to A12 for respective merchandise display places 8 (see FIG. 4) for merchandise 2. The respective blocks from 10 A1 to A12 are determined to have regions (sections) conforming to the sizes of the merchandise display places 8. In the embodiment, the respective blocks A1 to A12 have the same size of 50 cm long and 80 cm wide, but the present invention is not limited to this size and the respective blocks can be set to have different sizes conforming to the sizes of the merchandise display places 8. In the embodiment, the merchandise display rack 1 has the size in a range from 0 to 320 cm in an X-axis direction when a line connecting positions where the sensor sections 20a to 20c are installed is set as a reference line 11.

The detection region 7a, the detection region 7b, and the detection region 7c defined by projection lights 30 emitted from the sensor sections 20a, 20b, and 20c are formed so as to cover the merchandise take-out and put-back regions 6 of the merchandise display rack 1 in a strip-shaped. In other words, the detection regions 7a to 7c include an opening of the merchandise display rack 1 which is the merchandise take-out and put-back regions 6. Therefore, the sensor section detects not only the object 3 approaching the merchandise 2 displayed on the merchandise display rack 1 or the merchandise display place 8 but also a background material which should not be detected as the detection object, for example, a fixed background material such as a pillar 9 or a wall in a shop, on which the merchandise display rack 1 is installed, a clerk or a customer positioned beside the merchandise display rack 1, or a moving background material such as an equipment apparatus such as a dolly.

More specifically, in order to capture information about merchandise to which customers pay attention, it is necessary to exclude position data regarding these background materials from an object to be detected. The system management section 40 according to the embodiment defines detection regions of the detection regions 7a, 7b, and 7c corresponding to the merchandise display places 8 of blocks A1 to A12 of the merchandise display rack 1 as upper limits of effective detection regions to perform effective information extraction processing for excluding position data of the background material detected in regions other than an effective detection region 12a, an effective detection region 12b, and an effective detection region 12c which are the effective detection region in order to exclude the position data of the background material.

FIG. 6 is a diagram showing a configuration of a position data table 100 stored in the storage section 44 of the system management section 40. The position data table 100 includes an X-axis distance area 102 and a detection object area 103 provided in association with a sensor identification data area 101. Sensor identification data which are transmitted from the sensor sections 20a, 20b, and 20c, for identifying the respective sensor sections from one another and position data which comprises distance data in the X-axis direction are stored in the sensor identification data area 101 and the X-axis distance area 102, respectively. “1” is stored in the detection object area 103 when the position data is position data which has been determined as a detection object by the effective information extraction processing, and “0” is stored in the detection object area 103 when the position data is position data which has been determined as non-detection object. It is possible to determine whether or not the position data should be a detection object based upon the data in the detection target area 103.

FIG. 7 is a diagram showing a configuration of the effective region table 110 stored in the storage section 44 of the system management section 40. The effective region table 110 functions as an effective region storage section, and it stores upper limits of sizes of effective detection regions 12 (effective detection regions 12a, 12b and 12c) which are effective detection regions of detection regions 7 (detection regions 7a, 7b and 7c) formed by sensor sections 20a, 20b, and 20c. An upper limit area 112 storing an upper limit (region information) of an effective detection region of each sensor section is provided in association with a sensor identification data area 111. In the embodiment, 320 cm is stored in the upper limit area 112 as an upper limit. Position data exceeding the upper limit is subjected to effective information extraction processing as position data of a background material out of a detection object, which has been calculated by reflection of a background material positioned outside effective detection regions 12a, 12b, and 12c to be excluded from the detection object.

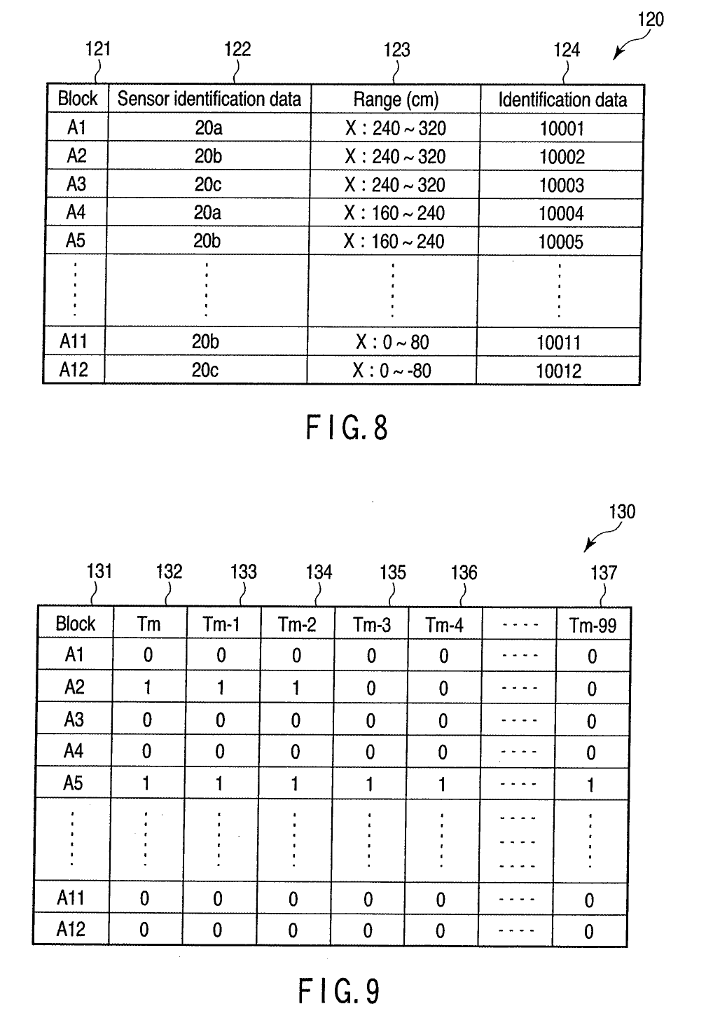

FIG. 8 is a diagram showing a configuration of a shelving allocation table 120 stored in the storage section 44 of the system management section 40. The shelving allocation table 120 functions as an article placement position storage section. A sensor identification data area 122 storing identification data of the sensor section which detects ranges in which respective blocks A1 to A12 of the merchandise display rack 1 are positioned, a range area 123 storing range data of respective blocks, and an identification data area 124 storing merchandise identification data (article identification information) of merchandise 2 (articles) displayed in respective blocks are provided in association with the block area 121. The range data stored in the range area 123 is data showing a range in the X-axis direction where each block is positioned when a line connecting positions where the sensor sections 20a, 20b, and 20c of the merchandise display rack 1 are installed is set as a reference line 11. The sensor identification data in the sensor identification data area 122 and the range data in the range area 123 function as article position information.

FIG. 9 is a diagram showing a configuration of a position specification table 130 stored in the storage section 44 of the system management section 40. A Tm area 132, a Tm-1 area 133, a Tm-2 area 134, a Tm-3 area 135, a Tm-4 area 136, . . . , a Tm-99 area 137 storing detection results of the object 3 in the effective detection areas 12 corresponding to respective blocks A1 to A12 of the merchandise display rack 1 are provided in this order in association with the block area 131.

The Tm area 132 to the Tm 99 area 137 store “1” therein when it is determined that the object 3 has been found in the effective detection area 12 corresponding to each block, but they store “0” therein when it is determined that the object 3 has not been found. The detection result of the object 3 is stored in the Tm area 132 for each block based upon the position data to which the effective information extraction processing has been applied. The past detection results are stored while moving the storage areas sequentially such that the detection result previously stored in the Tm area 132 is stored in the Tm-1 area 133, the detection result stored in the Tm-1 area 133 is stored in the Tm-2 area 134, and the detection result stored in the Tm-2 area 134 is stored in the Tm-3 area 135. In the embodiment, the detection results corresponding to 100 times can be stored. When the detection cycle of the sensor section 20a, the sensor section 20b, and the sensor section 20c is 10 Hz, the detection results for the past 10 seconds can be stored by storing the detection results corresponding to 100 times.

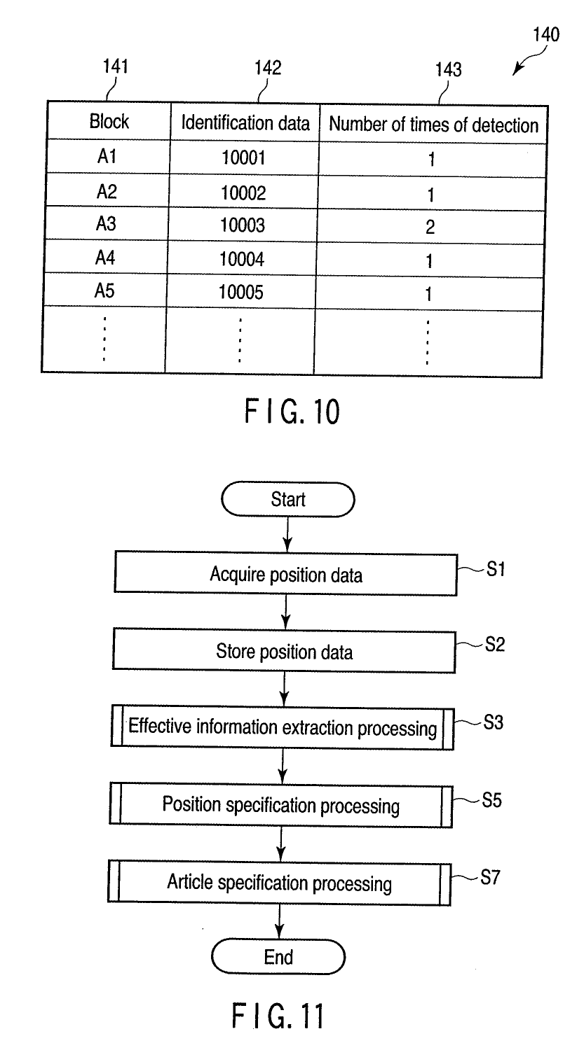

FIG. 10 is a diagram showing a configuration of the article specification table 140 stored in the storage section 44 of the system management section 40. An identification data area 142 and a number of detection times area 143 are provided for each of blocks A1 to A12 of the merchandise display rack 1 in association with a block area 141. A block which the object 3 approaches, merchandise displayed on the block, and the number of approach times can be determined with reference to the article specification table 140.

A processing of the article management system 80 will be explained with flowcharts shown in FIGS. 11 to 14.

FIG. 11 is a diagram showing a flowchart of processing for specifying the merchandise 2 displayed on the merchandise display rack 1 or the merchandise displaying place 8 which the object 3 approaches, which is performed by the MPU 41 which is the control section of the system management section 40.

The system management section 40 sequentially receives and acquires position data corresponding to one times detected by the sensor sections 20a, 20b, and 20c from the sensor sections 20a, 20b, and 20c (step S1, an object position acquiring section). The received position data is stored in the position data table 100 (step S2).

In the embodiment, the sensor sections 20a, 20b, and 20c calculate distance data of the object 3, respectively, and transmit position data comprising sensor identification data identifying each sensor section and distance data. The sensor identification data of each sensor section is stored in the sensor identification data area 101 of the position data table 100 based upon the received position data and distance data is stored in the X-axis distance area 102 in association with the sensor identification data stored in the sensor identification data area 101.

Effective information extraction processing is performed using the distance data stored in the X-axis distance area 102 of the position data table 100, and upper limit data (region information) of the effective detection regions 12 (effective detection region 12a, effective detection region 12b, and effective detection region 12c) stored in the upper limit areas 112 of the effective region table 110 (effective region storage section) (step S3).

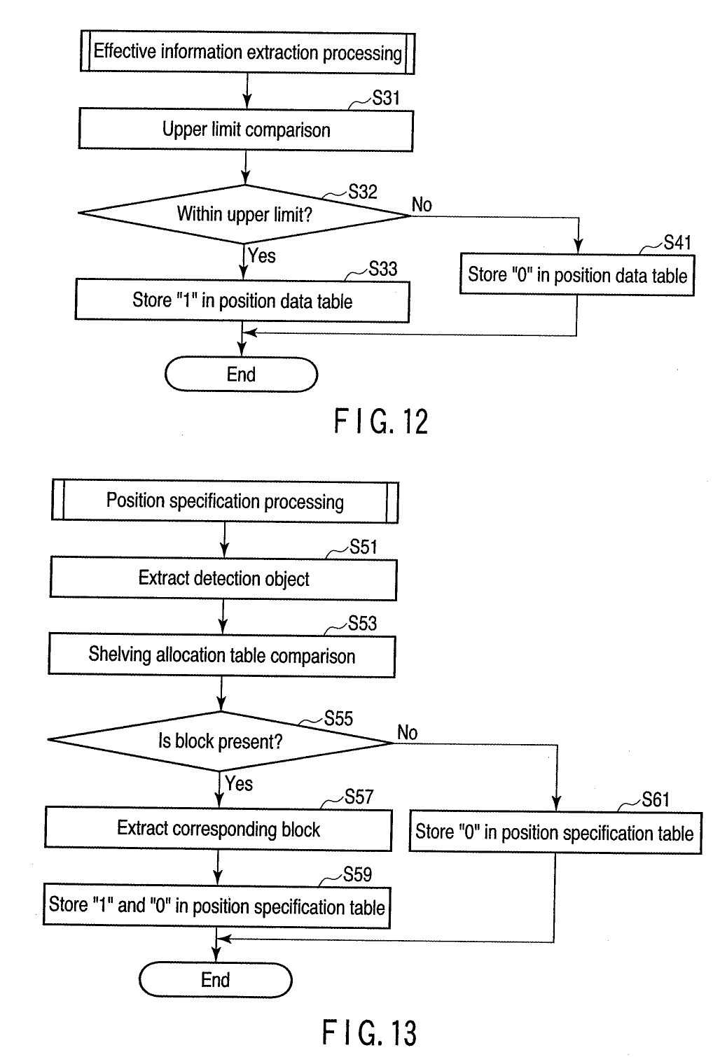

FIG. 12 is a diagram showing a flowchart of the effective information extraction processing performed by the MPU 41 which is the control section of the system management section 40. The effective information extraction processing functions as an effective information extraction section.

The distance data stored in the X-axis distance area 102 of the position data table 100 and detected by the sensor section 20a, the sensor section 20b, or the sensor section 20c is compared with the upper limit data in the effective detection region 12 (effective detection region 12a, effective detection region 12b, effective detection region 12c) of each sensor section stored in the upper limit area 112 of the effective region table 110 (step S31).

It is determined whether the distance data stored in the X-axis distance area 102 of the position data table 100 falls within the upper limit data in the effective detection region 12 (effective detection region 12a, effective detection region 12b, effective detection region 12c) of each sensor section stored in the upper limit area 112 of the effective region table 110 (step S32). When it is determined that the distance data does not fall within the upper limit data (NO in step S32), it is determined that the object 3 has been detected outside the effective detection region 12 of the merchandise display rack 1, so that “0” is stored in the detection target area 103 of the position data table 100 (step S41) and the effective information extraction processing is terminated.

When it is determined that the distance data falls within the upper limit data (YES in step S32), it is determined that the object 3 has been detected within the effective detection region 12 of the merchandise display rack 1, so that “1” is stored in the detection target area 103 of the position data table 100 (step S41) and the effective information extraction processing is terminated.

In the effective information extraction processing, it is determined whether or not the position where the object 3 has been detected falls within the effective detection region 12 (effective detection region 12a, effective detection region 12b, effective detection region 12c) of each sensor section (the sensor section 20a, the sensor section 20b, the sensor section 20c). This is for specifying the position such that only the object 3 approaching the merchandise 2 displayed on the merchandise display rack 1 or the merchandise display place 8 is an object to be detected. By the effective information extraction processing, it is made possible to exclude, from the detection result, position data of background materials which should not be tallied as objects approaching the merchandise, such as clerks and/or customers moving around the merchandise display rack 1, pillars or walls around the merchandise display rack 1, or equipment apparatuses.

Next, position specification processing is performed using the position data table 100 and the shelving allocation table 120 (step S5).

FIG. 13 is a diagram showing a flowchart of the position specification processing performed by the MPU 41 which is the control section of the system management section 40.

Position data stored in the position data table 100 which is stored in the detection object area 103 as “1” is extracted as position data of the object 3 (step S51).

The sensor identification data of the extracted position data stored in the sensor identification area 101 and the distance data stored in the X-axis distance area 102 are compared with the sensor identification data in the sensor identification area 122 in the shelving allocation table 120 and the range data showing a range where each of blocks A1 to A12 stored in the range area 123 is positioned (step S53).

It is determined whether the sensor identification data of the extracted position data coincides with the sensor identification data stored in the sensor identification data area 122 and the block storing the range data in which the distance data is included in the range area 123 is stored in the shelving allocation table 120 (step S55). When it is determined that there is no corresponding block 10 in the shelving allocation table 120 (NO in step S55), “0” is stored in the Tm areas 132 of all blocks of the position specification table 130 as the detection results (step S61) and the position specification processing is terminated.

When it is determined that there is a corresponding block in the shelving allocation table 120 (YES in step S55), the corresponding block is extracted (step S57), and “1” is stored in the Tm area 132 of a corresponding block in the position specification table 130 as the detection result, while “0” is stored in the Tm areas 132 of non-corresponding blocks as the detection results (step S59).

At this time, the past detection results are stored while sequentially moving the storage areas such that the detection result previously stored in the Tm area 132 is stored in the Tm-1 area 133, the detection result stored in the Tm-1 area 133 is stored in the Tm-2 area 134, the detection result stored in the Tm-2 area 134 is stored in the Tm-3 area 135, and the detection result stored in the Tm-3 area 135 is stored in the Tm-4 area 136. The detection result of the object 3 is stored in each of blocks A1 to A12 on the position specification table 130 so that the position specification processing is terminated.

Next, article specification processing is performed using the position specification table 130 storing the detection results and the shelving allocation table 120 (step S7).

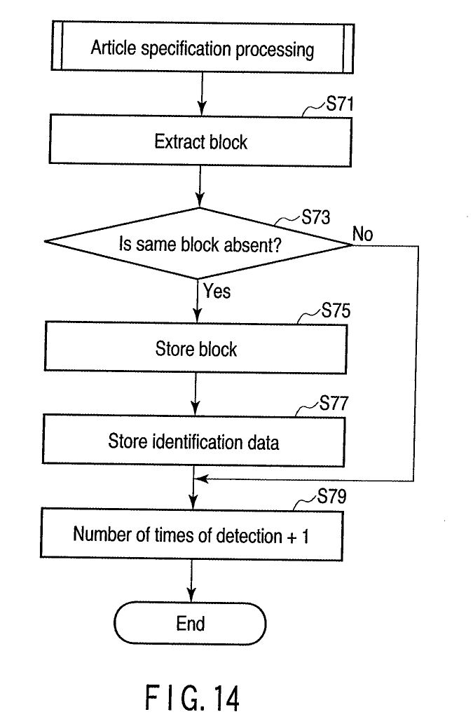

FIG. 14 is a diagram showing a flowchart of the article specification processing performed by the MPU 41 which is the control section of the system management section 40. The article specification processing functions as an article specification section.

Merchandise 2 displayed at a position which the object 3 approaches is specified using the detection result of the object 3 for each of blocks A1 to A12 stored in the Tm areas 132 of the position specification table 130 and the merchandise identification data stored in the identification data area 124 of the shelving allocation table 120.

First, the block storing “1” where the object 3 has been detected within the effective detection region 12 (effective detection region 12a, effective detection region 12b, effective detection region 12c) is extracted from the detection results stored in the Tm areas 132 in the position specification table 130 (step S71).

It is determined whether the same block as the extracted block has been not stored in the block area 141 in the article specification table 140 (step S73). When it is determined that the same block has been stored in the block area 141 in the article specification table 140 (NO in step S73), “1” is added to the count of the number of detection times area 143 of a corresponding block in the article specification table 140 (step S79) and the article specification processing is terminated.

When it is determined that the same block has not been stored in the block area 141 in the article specification table 140 (YES in step S73), the block is stored in the block area 141 in the article specification table 140 (step S75).

The merchandise identification data with which the same block as the block stored in the block area 141 in the article specification table 140 is associated is selected from the identification data area 123 on the shelving allocation table 120 to be stored in the identification data area 142 in the article specification table 140 (step S77).

“1” is added to the count of the number of detection times area 143 of the corresponding block in the article specification table 140 (step S79) and the article specification processing is terminated.

The block data stored in the block area 141 in the article specification table 140, the merchandise identification data stored in the identification data area 142, and the number of detection times data stored in the number of detection times area 143 are stored in association with one another by the article specification processing. The block data stored in the block area 141 in the article specification table 140 is a block where the object 3 has approached the merchandise 2 displayed on the merchandise display rack 1 or the merchandise display place 8 and it has been detected within the effective detection region, so that it is made possible to specify the merchandise identification data of the merchandise 2 which the object 3 approaches with reference to the merchandise identification data stored in the identification data area 142 associated with the block data. Further, it is made possible to tally the number of detections of the merchandise 2 which the object 3 approaches with reference to the number of detection times data stored in the number of detection times area 143 associated with the block data.

In the embodiment, by detecting the object 3 such as a hand(s) or an arm(s) of a customer(s) approaching the merchandise 2 displayed on the merchandise display rack 1 or the merchandise display place 8, it is made possible to examine the merchandise which has been selected and picked up by a customer(s) regardless of purchase of the merchandise performed by the customer(s). Thereby, it is made possible to examine the merchandise to which customers pay attention for each merchandise specifically. By implementing the present invention before and after change of shelving allocation layout of a merchandise display rack, it is made possible to examine good or bad of the shelving allocation layout of the merchandise display rack for each merchandise more specifically.

Since infrared laser light is used as the light source for the sensor section 20 configuring the object detection section, a measurement range is broad so that influence of optical conditions such as illumination in a shop or a warehouse can be reduced. Since the system configuration is simple, installation or maintenance of the system can be made relatively easy even in an all-hours shop where customers come and go heavily or the like.

By installing the sensor section 20 on the side of the opening on the shelf front 4 side where the merchandise take-out and put-back region 6 of the merchandise display rack 1 is present, it is made possible to form the detection region (the effective detection region 12) for detecting the object 3 on the opening side. Thereby, it is made possible to examine merchandise to which customers pay attention more accurately by detecting the merchandise as the object 3 when the merchandise has been picked up by customers.

By installing the sensor section 2 corresponding to each of a plurality of shelves in the merchandise display rack 1, accurate detection is made possible even if a plurality of customers approach merchandise 2 displayed on different shelves, respectively.

It should be noted that the present invention is not limited to the embodiment as it is, but it can be embodied while constituent elements thereof are modified in an implementation stage without departing from the gist of the invention.

In the embodiment, for example, the present invention has been applied to the article management system performing management of an article such as merchandise or a sample at a shop such as a retail outlet but it is not limited to this example and the present invention can be applied to an article management system managing articles such as parts or members in a warehouse or the like.

In the embodiment, the present invention has been applied to the vertical-type merchandise display rack having shelves for displaying merchandise arranged vertically but it is not limited to this example and the present invention can be applied to a merchandise display stand such as a flat base on which a plurality of merchandise is displayed approximately horizontally in a sectioned manner or on a wagon.

Besides, various inventions can be configured by proper combinations of a plurality of constituent elements disclosed in the embodiment. For example, some constituent elements can be removed from all the constituent elements disclosed in the embodiment. Further, constituent elements included in different embodiments can be combined properly.

### Second Embodiment

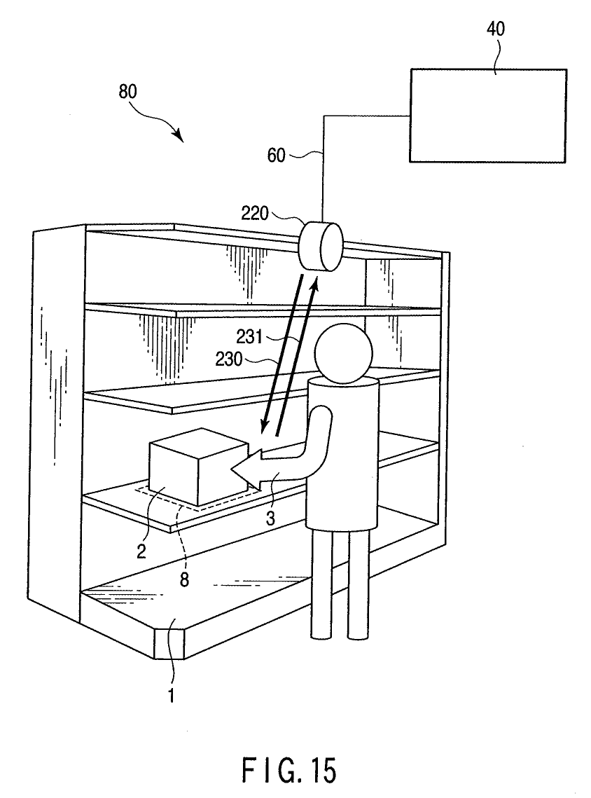

A second embodiment of the present invention will be explained with reference to FIGS. 15 to 30. Explanation about parts or members similar to those in the first embodiment is omitted.

FIG. 15 is a diagram showing a configuration of an article management system 80 according to the second embodiment of the present invention. The article management system 80 comprises a sensor section 220 (object detection section) and a system management section 40 (information processing apparatus).

The sensor section 220 is installed, for example, on a merchandise display rack 1 (placement part) in a shop and, when it detects an object 3 which approaches merchandise 2 (article) displayed on the merchandise display rack 1 or a merchandise display place 8 (article placement region), it measures a distance from the sensor section 220 to the object 3 to transmit measured distance data to the system management section 40 as position data of the object 3 (object position information).

As a method where the sensor section 220 measures a distance to the object 3, for example, there is a method of projecting projection light 230 comprising infrared laser light as infrared ray with a wavelength in a range from about 0.7 μmm to 0.1 mm from the sensor section 220 to the object 3 and detecting reflected light 231 reflected from the object 3 at the sensor section 220 to measure a distance to the object 3 based upon a time difference between a projection time of the projection light 230 and a detection time of the reflected light 231.

In the second embodiment, the sensor section 220 measures the distance to the object 3 utilizing the projection light 230 comprising infrared laser light, but the method where the sensor section 220 measures distance is not limited to this method, but, for example, a method of projecting an ultrasonic wave, which is an acoustic wave with a frequency of about 20 kHz or higher, and detecting a reflected wave thereof to measure the distance to the object 3 utilizing the projection time of the ultrasonic wave and the detection time of the reflected wave, as with infrared laser light, can be adopted.

The system management section 40 is connected to the sensor section 220 via a communication line 60 such as an LAN or a dedicated line and it receives position data of the object 3 transmitted and output by the sensor section 220 to perform a processing based upon the received position data.

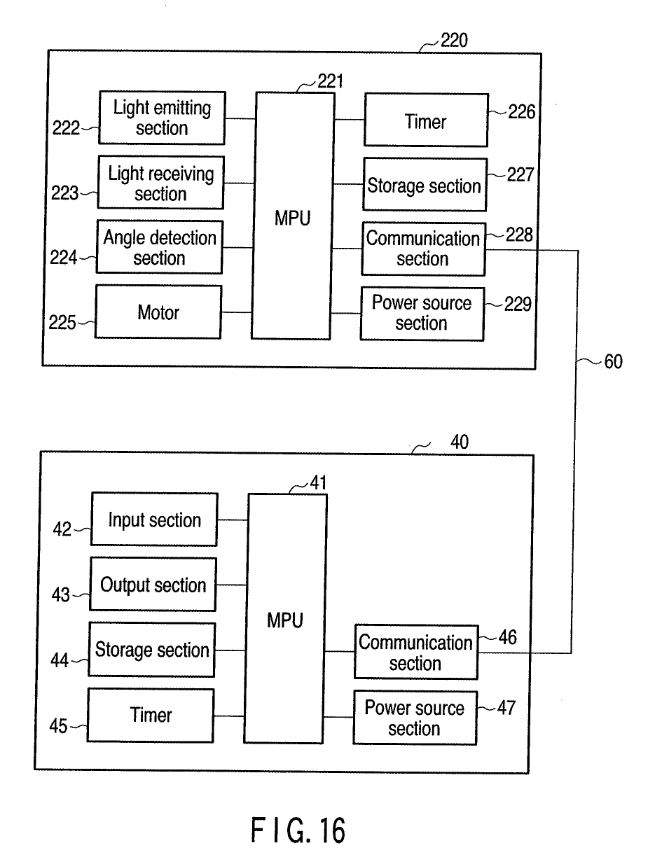

FIG. 16 is a diagram showing a hardware configuration of the article management system 80 according to the second embodiment. The sensor section 220 comprises a microprocessing unit (MPU) 221 which is a control section performing control of each hardware of the sensor section 220, a light emitting section 222 (projection section) emitting projection light 230 for detecting an object 3, a light receiving section 223 (detection section) detecting reflected light 231 from the object 3, an angle detection section 224, a motor section 225, a timer section 226, a storage section 227 such as a hard disk or a memory, a communication section 228 performing transmission and reception of data between the same and the system management section 40, a power source section 229, and the like. Functions of the respective sections will be explained later.

The system management section 40 comprises a microprocessing unit (MPU) 41 which is a control section performing control of each hardware of the system management section 40, an input section 42 such as a keyboard or a mouse, an output section 43 such as a display device such as a liquid crystal display or an organic EL display, or a printer, a storage section 44 such as a hard disk or a memory, a timer section 45, a communication section 46 performing transmission and reception of data with the sensor section 220 or another system, a power source section 47, and the like. A position data table 300, an effective region table 310, a shelving allocation table 320, a position specification table 330, and an article specification table 340 are provided in the storage section 44.

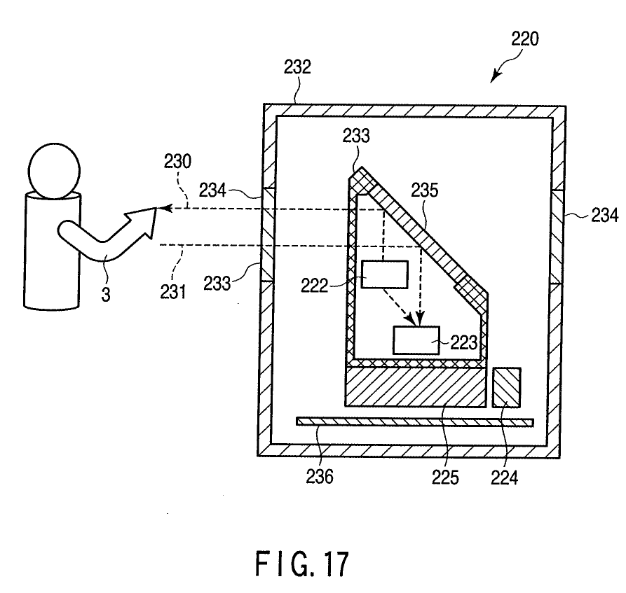

The sensor section 220 functioning as an object detection section of the article management system 80 will be explained with reference to FIGS. 17 to 21.

FIG. 17 is a diagram showing a configuration of the sensor section 220. The sensor section 220 comprises a casing 232, a rotary body 233, an angle detection section 224, a sensor control section 236, and the like. The casing 232 is formed, for example, in a cylindrical shape, and it is provided with an annular transparent window 234 opened over a range of 180° along a circumferential direction. The rotary body 233 comprises a light emitting section 222 (projection section), a light receiving section 223 (detection section), a motor section 225, a light projection and receiving mirror 235, and the like. The light emitting section 222 (light projection section) comprises a light source such as, for example, an infrared laser or an LED, and the light receiving section 223 (detection section) comprises an optical sensor such as a photodiode. The motor section 225 comprises, for example, a blushless DC motor or the like.

The light projection and receiving mirror 235 is provided with a function of reflecting projection light 230 emitted by the light emitting section 222 in a predetermined direction and reflecting reflected light 231 reflected by the object 3 in a direction of the light receiving section 223. The light projection and receiving mirror 235 rotates together with the rotary body 233, for example, at 10 Hz so that the projection light 230 emitted from the light emitting section 222 can be projected about the sensor section 220 via the light projection and receiving mirror 235, for example, in a range of 180° along the transparent window opened in a range of an angle of 180° to perform scanning about the sensor section 220 in a two-dimensional manner. The angle detection section 224 comprises, for example, a photointerrupter, a magnetic sensor, or the like to detect and output a rotational angle of the rotary body 233.

The sensor control section 236 functions as an object position calculation section. The sensor control section 236 comprises the MPU 221, the timer section 226, the storage section 227, the communication section 228, the power source section 229, and the like (see FIG. 16), and it performs rotational control of the motor section 225 and measures an angle θ of the rotating rotary body 233 based upon a signal output from the angle detection section 224. It is possible to set an angle reference line of the angle θ of the rotary body 233 to be obtained arbitrarily. For example, the angle detection section 224 has, for example, an angle detection resolution of 1 degree and it can measure and output the angle θ of the rotary body 233 for each one degree from an arbitrary angle reference line.

The sensor control section 236 controls emission of the light emitting section 222 while controlling the motor section 225 to rotate the rotary body 233. Projection light 230 emitted by the light emitting section 222 is projected via the light projection and receiving mirror 235 and the transparent window 234 to perform scanning about the sensor section 220, for example, with 10 Hz. When an object 3 is present in a region of the scanning, reflected light 231 is emitted from the object 3 so that the reflected light 231 is detected at the light receiving section 223 via the transparent window 234 and the light projection and receiving mirror 235.

As in the first embodiment, the sensor control section 236 calculates a distance r from the sensor section 220 to the object 3 from a time difference between a time at which the light emitting section 222 has emitted the projection light 230 and a time at which the light receiving section 223 has detected the reflected light 231, a reciprocating time from the emission to detection and velocities of the projection light 30 serving as a reference and the reflected light 31 to transmit and output position data comprising the calculated distance r and an angle θ output by the angle detection section 224 to the system management section 40. In the embodiment, the sensor section 220 measures the distance to the object 3 utilizing the projection light 30 comprising infrared laser light, but such a configuration can be adopted, as with infrared laser light, that an ultrasonic wave is projected, a reflected wave thereof is detected, and the distance to the object 3 is measured from the projection time of the ultrasonic wave and the detection time of the reflected light.

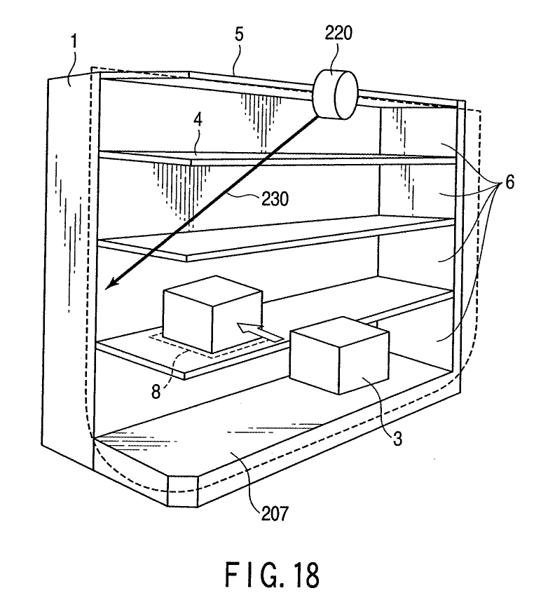

FIG. 18 is a diagram showing a state that the sensor section 220 has been installed on the merchandise display rack 1. The sensor section 220 detects an object 3 approaching merchandise 2 (article) displayed on the merchandise display rack 1 or a merchandise display place 8 (article placement region) of the merchandise 2. The sensor section 220 is installed, for example, at an approximately central upper part of a shelf peripheral part 5 on a shelf front 4 side where an opened merchandise take-out and put-back region 6 (opening) of the merchandise display rack 1 is present. A detection region 207 serving as a reference for detecting an object 3 is formed on a front of the merchandise take-out and put-back region 6 so as to cover the merchandise take-out and put-back region 6 by projection light 230 emitted from the sensor section 220 downwardly in a range of 180°.

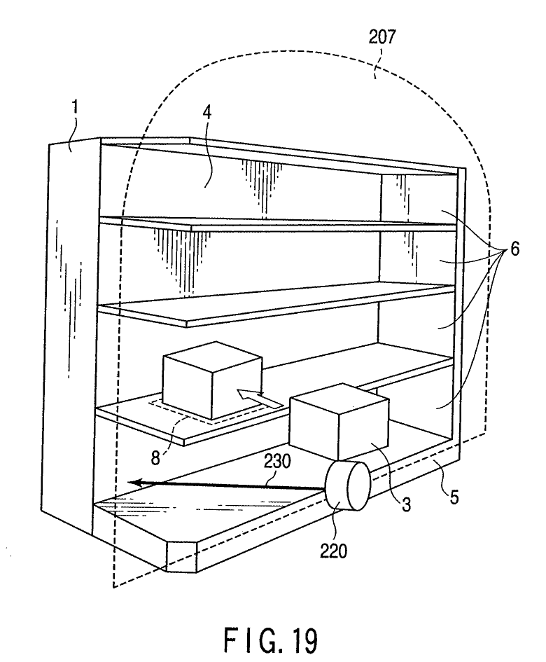

FIG. 19 is a diagram showing a state that the sensor section 220 has been installed at an approximately central lower part of the shelf peripheral part 5 on the shelf front 4 side where an opened merchandise take-out and put-back region 6 (opening) of the merchandise display rack 1 is present. A detection region 207 serving as a reference for detecting an object 3 is formed on a front of the merchandise take-out and put-back region 6 so as to cover the merchandise take-out and put-back region 6 by projection light 230 emitted from the sensor section 220 upwardly in a range of 180°. It should be noted that it is unnecessary to limit an installation place of the sensor section 220 to the upper part or the lower part of the shelf peripheral part 5 if the sensor section 220 can detect the object 3 approaching the merchandise 2 or the merchandise display place 8 of the merchandise 2, but the sensor section 220 can be provided on each of both the upper part and the lower part, or it can be provided on one of the right and left side parts or each thereof. That is, one or more sensor sections 220 can be installed at a place(s) where they can detect the object 3 approaching the merchandise 2 or the merchandise display place 8 of the merchandise 2.

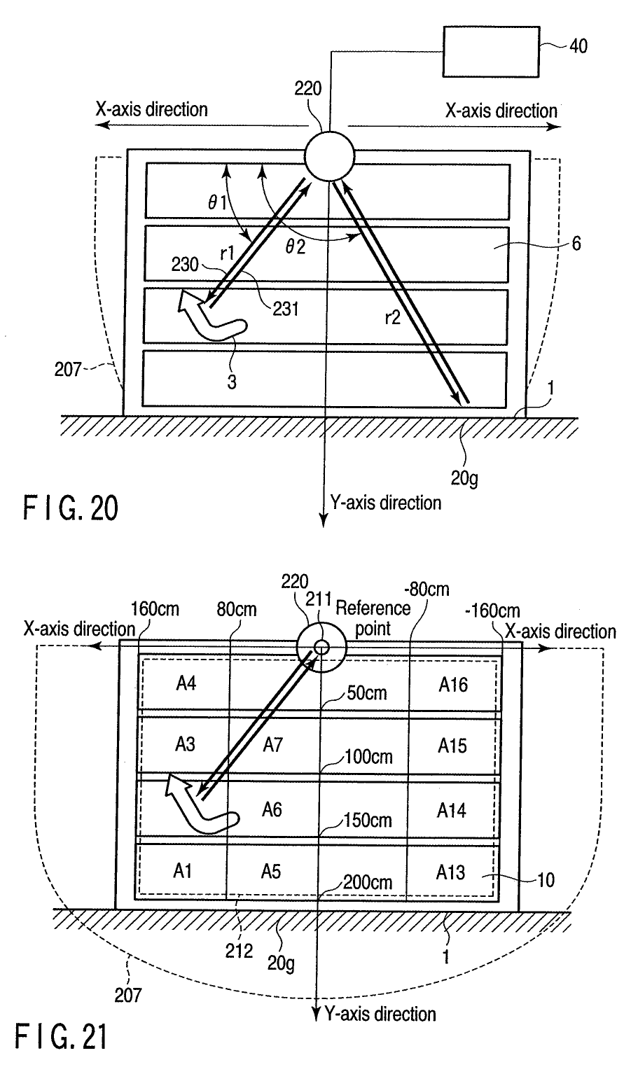

FIG. 20 is a diagram showing a state that the merchandise display rack 1 where the sensor section 220 has been installed has been viewed from the shelf front 4 side. The projection light 230 is projected from the sensor section 220 installed at the approximately central upper part of the shelf peripheral part 5 of the merchandise display rack 1 downwardly in a range of 180° around the sensor section 220.

As described above, since the projection light 230 projected from the sensor section 220 rotates, for example, at a cycle of 10 Hz to perform scanning around the sensor section 220, the detection region 207 is formed so as to cover the merchandise take-out and put-back region 6 of the merchandise display rack 1. When the object 3 contacts with the detection region 207, the projection light 230 projected from the sensor section 220 is reflected by the object 3 so that the reflected light 231 thereof can be detected by the sensor section 220.

As described above, the sensor control section 236 calculates the distance r to the object 3, detects an angle θ, and transmits and outputs position data comprising the distance r and the angle θ to the system management section 40 for each scanning.

FIG. 21 is a diagram showing a state that the merchandise display rack 1 has been sectioned to blocks 10 A1 to A16 for respective merchandise display places 8 of merchandise 2. Regions of the respective blocks 10 from A1 to A16 are determined so as to conform to sizes of the merchandise display places 8. In the embodiment, the respective blocks 10 from A1 to A16 are set to have the same size of 50 cm long and 80 cm wide, but the present invention is not limited to this size and the respective blocks can be set to have different sizes conforming to the sizes of the merchandise display places 8. In the embodiment, the size of the merchandise display rack 1 is in a range from 160 to −160 cm in an X-axis direction and in a range from 0 to 200 cm in a Y-axis direction when a position where the sensor section 220 is installed is set as a reference point 211.

Since the detection region 207 defined by the projection light 230 emitted from the sensor section 220 is formed so as to cover the merchandise take-out and put-back region 6 of the merchandise display rack 1, the sensor section 220 detects not only the object 3 approaching the merchandise 2 displayed on the merchandise display rack 1 or the merchandise display place 8 but also a fixed background material which should not be detected as the detection object such as a floor 209, a wall or a pillar of a building in a shop, to which the merchandise display rack 1 is installed, or a moving background material such as a clerk or a customer positioned beside the merchandise display rack 1, or an equipment apparatus such as a dolly.

More specifically, in order to capture information about merchandise to which customers pay attention, it is necessary to exclude position data regarding these background materials from an object to be detected. The system management section 40 according to the embodiment defines a detection region of the detection region 207 corresponding to the merchandise display places 8 of blocks A1 to A16 of the merchandise display rack 1 as an upper limit of an effective detection region to perform effective information extraction processing for excluding position data of the background material detected in an region other than an effective detection region 212 which is the effective detection region in order to exclude the position data of the background materials.

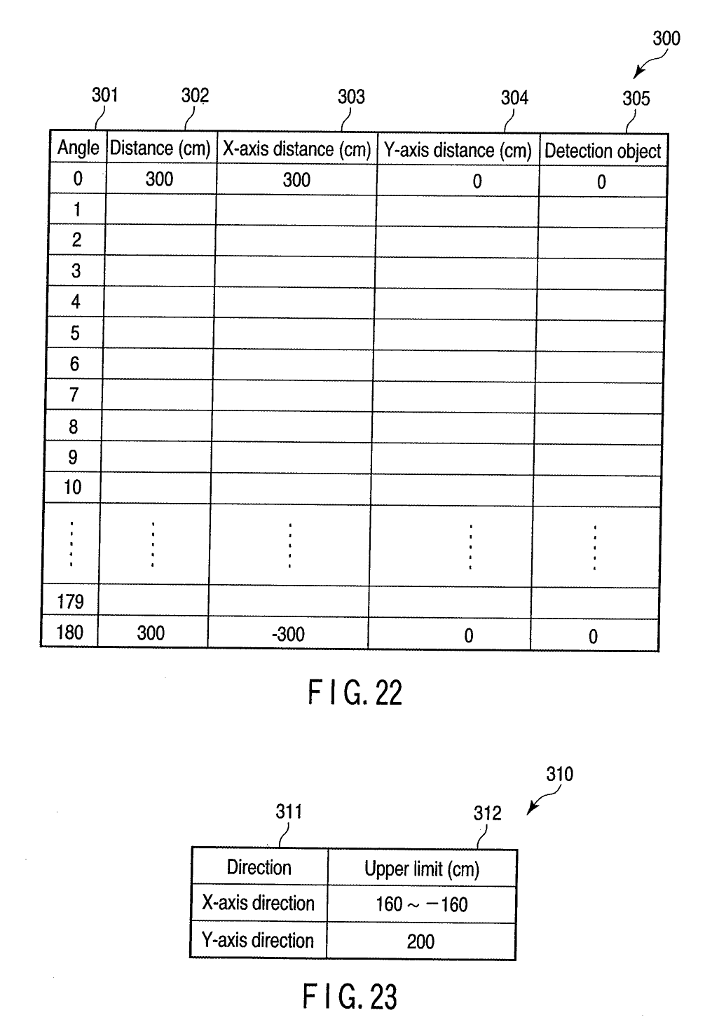

FIG. 22 is a diagram showing a configuration of a position data table 300 stored in the storage section 44 of the system management section 40. The position data table 300 includes a distance area 302, an X-axis distance area 303, a Y-axis distance area 304, and a detection object area 305 provided in association with an angle area 301. Angle data of position data comprising angle θ and distance r and transmitted from the sensor section 220 is stored in the angle area 301 and distance data thereof is stored in the distance area 302 in association with the angle data. Distance data of the object 3 in the X-axis direction and distance data thereof in the Y-axis direction are calculated from the angle data stored in the angle area 301 and the distance data stored in the distance area 302 and they are stored in the X-axis distance area 303 and the Y-axis distance area 304, respectively. The detection object area 305 stores “1” therein regarding position data which is to be detected according to the effective information extraction processing and it stores “0” therein regarding position data which is not to be detected. It is possible to determine whether the position data is to be detected according to data in the detection object area 305.

FIG. 23 is a diagram showing a configuration of the effective region table 310 stored in the storage section 44 of the system management section 40. The effective region table 310 functions as an effective region storage section and it stores an upper limit of a size of the effective detection region 212 which is an effective region of the detection region 207 formed by the sensor section 220. An upper limit area 312 storing an upper limit (region information) in each direction is provided in association with a direction area 311. In the embodiment, a position where the sensor section 220 is installed is set as a reference point, 160 to −160 cm regarding the X-axis direction and 200 cm regarding the Y-axis direction are stored in the upper limit area 312 as the upper limits of the respective directions. Position data exceeding the upper limit is subjected to the effective information extraction processing as position data of the background material outside the detection object, which has been calculated as reflection of a background material present outside the effective detection region 212 to be excluded from the detection object.

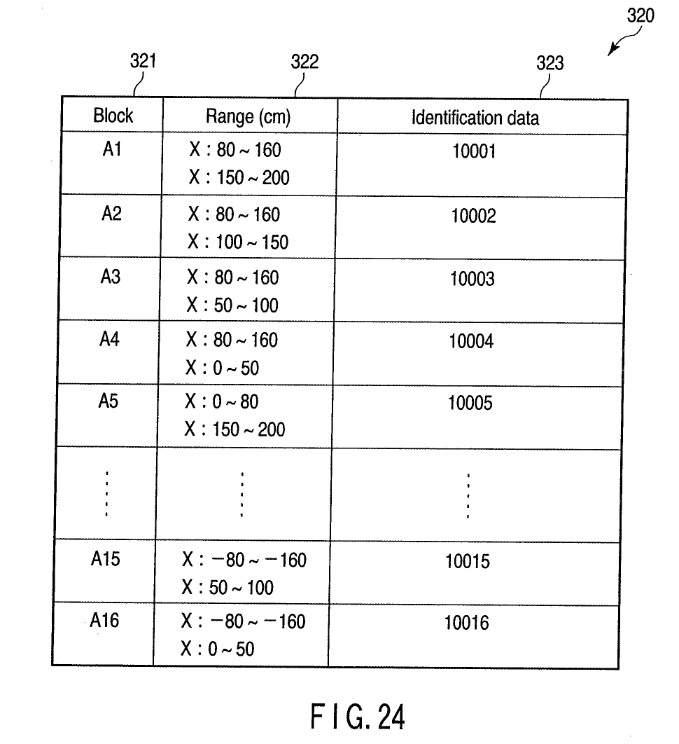

FIG. 24 is a diagram showing a configuration of the shelving allocation table 320 stored in the storage section 44 of the system management section 40. The shelving allocation table 320 functions as an article placement position storage section. A range area 322 storing range data (article position information) showing a range where each of blocks A1 to A16 of the merchandise display rack 1 is positioned and an identification data area 323 storing merchandise identification data (article identification information) of merchandise 2 (article) displayed in each block are provided in association with the block area 321. Range data stored in the range area 322 is data showing ranges in the X-axis direction and the Y-axis direction where each block is positioned when a position where the sensor section 220 of the merchandise display rack 1 is installed is defined as a reference point.

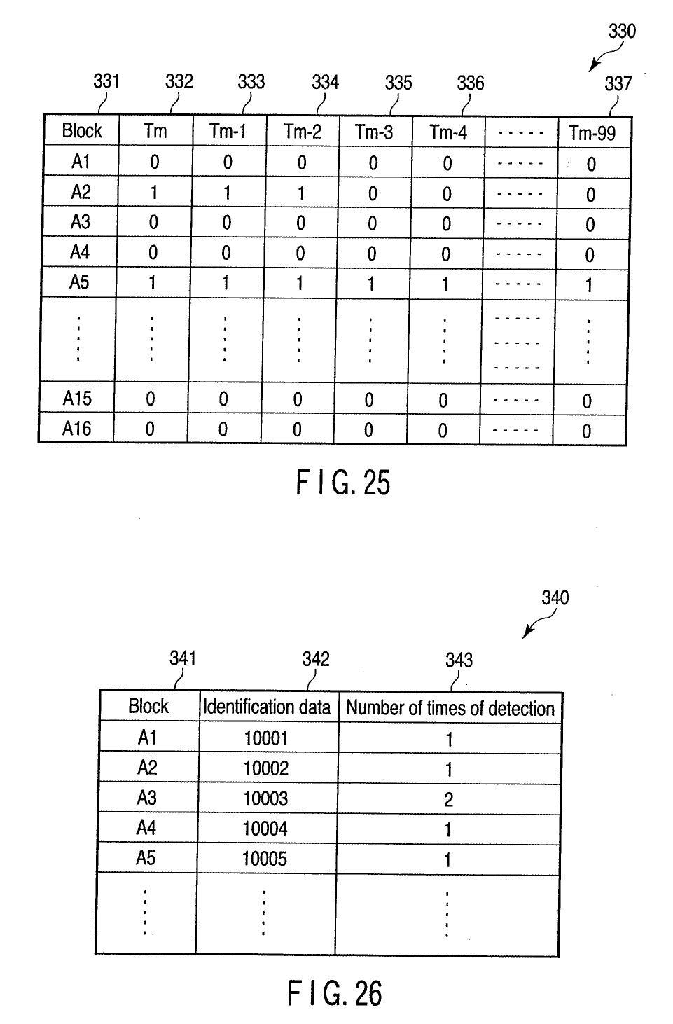

FIG. 25 is a diagram showing a configuration of the position specification table 330 stored in the storage section 44 of the system management section 40. A T-m area 332, a Tm-1 area 333, a Tm-2 area 334, a Tm-3 area 335, a Tm-4 area 336, . . . , a Tm-99 area 337 storing a detection result of the object 3 in the effective detection region 212 corresponding to each of blocks A1 to A16 of the merchandise display rack 1 are provided in this order in association with the block area 331.

When it is determined that the object 3 has been detected in the effective detection region 212 corresponding to each block, “1” is stored in the Tm area 332 to the Tm-99 area 337, but when it is determined that the object 3 has not been detected, “0” is stored the Tm area 332 to the Tm-99 area 337. The detection result of the object 3 is stored in the Tm area 332 for each block based upon the position data which has been subjected to the effective information extraction processing. The past detection results are stored while moving the storage areas sequentially such that the detection result which has been previously stored in the Tm area 332 is stored in the Tm-1 area 333, the detection result which has been stored in the Tm-1 area 333 is stored in the Tm-2 area 334, and the detection result which has been stored in the Tm-2 area 334 is stored in the Tm-3 area 335. In the embodiment, the detection results corresponding to 100 times can be stored. When the scanning cycle of the sensor section 220 is 10 Hz, the detection results for the past 10 seconds can be stored by storing the detection results corresponding to 100 times.

FIG. 26 is a diagram showing a configuration of the article specification table 340 stored in the storage section 44 of the system management section 40. An identification data area 342 and a number of detection times area 343 are provided for each of blocks A1 to A16 of the merchandise display rack 1 in association with the block area 341. It is made possible to determine the block which the object 3 has approached, merchandise on the block, and the number of approach times with reference to the article specification table 340.

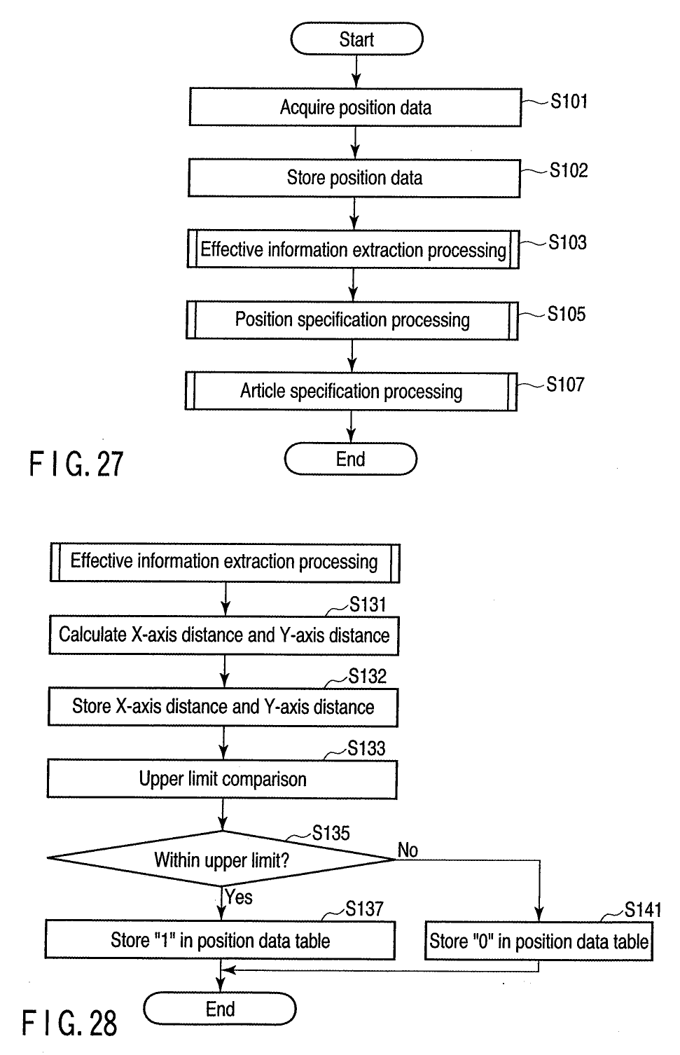

A processing of the article management system 80 will be explained with flowcharts shown in FIGS. 27 to 30.

FIG. 27 is a diagram showing a flowchart of processing for specifying merchandise 2 (article) displayed on the merchandise display rack 1 (placement part) or the merchandise display place 8 (article placement region) which the object 3 approaches, which is executed by the MPU 41 which is the control section of the system management section 40.

The system management section 40 (information processing apparatus) receives and acquires position data (object position information) corresponding to one-time scanning performed by the sensor section 220 (object detection section) from the sensor section 220 (step S101, object position acquiring section). The received position data is stored in the position data table 300 (step S102).

In the embodiment, since the sensor section 220 calculates position data for each one degree from 0° to 180° and transmits position data of angle from 0° to 180° corresponding to one-time scanning collectively, the received position data is stored in the position data table 300 in association with the angle from 0° to 180°. The effective information extraction processing is performed using the position data stored in the position data table 300 and the upper limit (region information) of the effective detection region 212 stored in the effective region table 310 (effective region storage section) (step S103).

FIG. 28 is a diagram showing a flowchart of the effective information extraction processing performed by the MPU 41 which is the control section of the system management section 40. The effective information extraction processing functions as an effective information extraction section.

X-axis distance data rx which is a distance of the detected object 3 in the X-axis direction and Y-axis distance data ry which is a distance in the Y-axis direction are calculated from the position data of an angle θ and a distance r stored in the position data table 300 (step S131). The X-axis distance data rx and the Y-axis distance data ry are calculated by the following equations.

rx=r×cos θ

ry=r×sin θ

The calculated X-axis distance data rx is stored in the X-axis distance area 303 of the position data table 300, and the calculated Y-axis distance data ry is stored in the Y-axis distance area 304 (step S132).

Next, the X-axis distance data stored in the X-axis distance area 303 and the Y-axis distance data stored in the Y-axis distance area 304 are compared with upper limits of the effective detection area 212 stored in the effective region table 310 (step S133).

It is determined whether or not the X-axis distance data and the Y-axis distance data corresponding to the position where the object 3 has been detected fall within the upper limits of the effective detection region 212 stored in the effective region table 310 (step S135). When it is determined that the X-axis distance data and the Y-axis distance data do not fall within the upper limits (NO in step S135), it is determined that the object 3 has been detected outside the effective detection region 212 of the merchandise display rack 1, so that “0” is stored in the detection object area 305 of the position data table 300 (step S141) and the effective information extraction processing is terminated.

When it is determined that the X-axis distance data and the Y-axis distance data fall within the upper limits (YES in step S135), it is determined that the object 3 has been detected inside the effective detection region 212 of the merchandise display rack 1 so that “1” is stored in the detection object area 305 of the position data table 300 (step S137) and the effective information extraction processing is terminated.

In the effective information extraction processing, it is determined whether or not the position where the object 3 has been detected falls within the effective detection region 212. This is for specifying the position such that only the object 3 approaching the merchandise 2 displayed on the merchandise display rack 1 or the merchandise display place 8 is the detection object. It is made possible to exclude, from the detection results, position data of the background material which should not be tallied as the object approaching the merchandise, such as a clerk(s) or a customer(s) moving around the merchandise display rack 1, a pillar(s), a wall(s), or an equipment apparatus(es) around the merchandise display rack 1 by the effective information extraction processing.

Next, the position specification processing is performed using the position data table 300 and the shelving allocation table 320 (step S105).

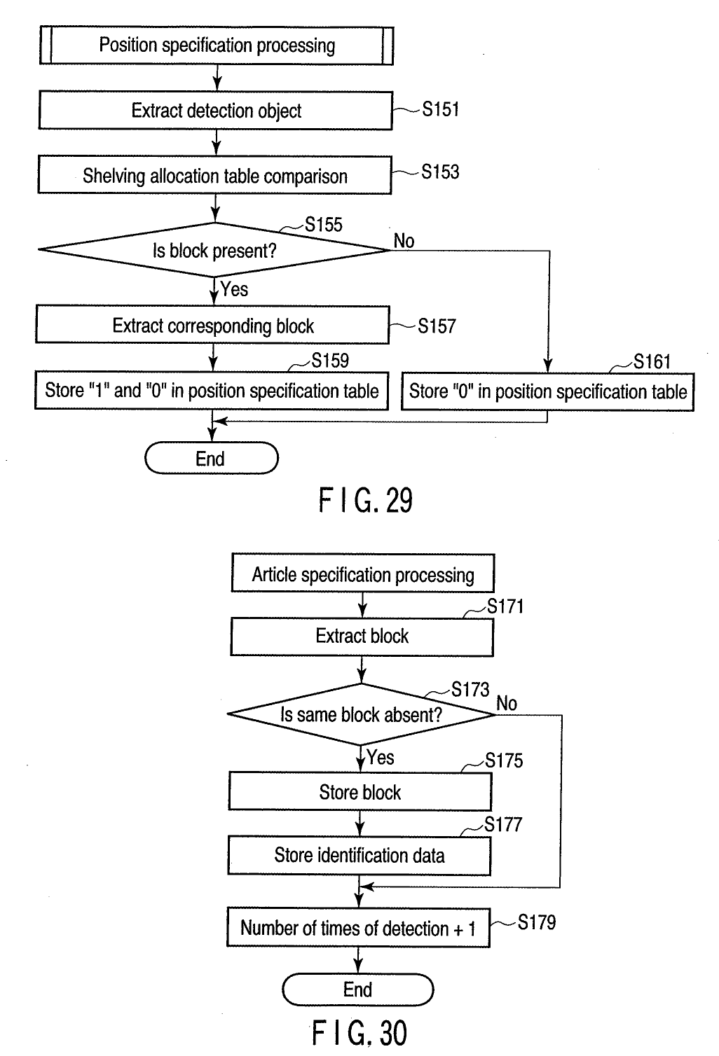

FIG. 29 is a diagram showing a flowchart of the position specification processing performed by the MPU 41 which is the control section of the system management section 40.

The position data of the position data stored in the position data table 300, which stores “1” in the detection object area 305 is extracted as position data of the object 3 to be detected (step S151).

The X-axis distance data stored in the X-axis distance area 303 of the extracted position data and the Y-axis distance data stored in the Y-axis distance area 304 thereof are compared with the range data defining a range where each of blocks A1 to A16 stored in the range area 322 of the shelving allocation table 320 is positioned (step S153).

It is determined whether or not the block 10 of the range data in which the X-axis distance data and the Y-axis distance data of the extracted position data are included is stored in the shelving allocation table 320 (step S155). When it is determined that the block 10 in which a position data is included is not present (NO in step S155), “0” is stored in the Tm areas 332 of all the blocks of the position specification table 330 as the detection results (step S161), and the position specification processing is terminated.

When it is determined that a block in which the position data is included is present (YES in step S155), the corresponding block is extracted (step S157) and “1” is stored in the Tm area 332 of the corresponding block of the position specification table 330 as the detection result and “0” is stored in the Tm areas 332 of the other blocks (step S159).

At this time, the past detection results are stored while sequentially moving the storage areas such that the detection result which has been previously stored in the Tm area 332 is stored in the Tm-1 area 333, the detection result which has been stored in the Tm-1 area 333 is stored in the Tm-2 334, the detection result which has been stored in the Tm-2 area 334 is stored in the Tm-3 area 335, and the detection result which has been stored in the Tm-3 area 335 is stored in the Tm-4 area 336. The detection result of the object 3 is stored in the position specification table 330 for each of blocks A1 to A16 so that the position specification processing is terminated.

Next, article specification processing is performed using the position specification table 330 storing the detection results and the shelving allocation table 320 (step S107).

FIG. 30 is a diagram showing a flowchart of the article specification processing performed by the MPU 41 which is the control section of the system management section 40. The article specification processing functions as an article specification section.

Merchandise 2 displayed at a position which the object 3 approaches is specified by using the detection result of the object 3 for each of blocks A1 to A16 stored in the Tm areas 332 of the position specification table 330 and the merchandise identification data stored in the identification data area 323 of the shelving allocation table 320.

First, a block storing “1” where the object 3 has been detected within the effective detection region 212 is extracted from the detection results stored in the Tm area 332 in the position specification table 330 (step S171).

It is determined whether the same block as the extracted block is not stored in the block area 341 in the article specification table 340 (step S173). When it is determined that the same block is stored in the block area 341 in the article specification table 340 (NO in step S173), “1” is added to the count of the number of detection times area 343 of a corresponding block in the article specification table 340 (step S179) and the article specification processing is terminated.

When it is determined that the same block is not stored in the block area 341 in the article specification table 340 (YES in step S173), the block is stored in the block area in the article specification table 340 (step S175).

The merchandise identification data associated with the same block as the block stored in the block area 341 in the article specification table 340 is selected from the identification data area 323 on the shelving allocation table 320 to be stored in the identification data area 342 in the article specification table 340 (step S177).

“1” is added to the count of the number of detection times area 343 of a corresponding block in the article specification table 340 (step S179) and the article specification processing is terminated.

The block data stored in the block area 341 in the article specification table 340, the merchandise identification data stored in the identification data area 342, and the number of detection times data stored in the number of detection times area 343 are stored in association with one another according to the article specification processing. The block data stored in the block area 341 in the article specification table 340 is a block which the object 3 has approached and has been detected within the effective detection region 212, and the merchandise identification data of the merchandise 2 which the object 3 approaches can be specified with reference to the merchandise identification data stored in the identification data area 342 associated with the block data. Further, the number of detection times of the merchandise 2 which the object 3 approaches can be tallied with reference to the number of detection times data stored in the number of detection times area 343 associated with the block data.

In the embodiment, by detecting an object 3 such as a hand or an arm of a customer approaching an article for a sale 2 displayed on the merchandise display rack 1 or a merchandise display place 8 for each merchandise, it is made possible to examine merchandise selected by a customer and picked up by his/her hand from the merchandise display rack regardless of presence or absence of customer's purchase. Thereby, it is made possible to examine merchandise to which customers pay attention for each merchandise more specifically. By implementing the present invention before and after change of shelving allocation layout of an merchandise display rack, it is made possible to examine good or bad of the shelving allocation layout of the merchandise display rack for each merchandise more specifically.

Since infrared laser light is used as the light source for the sensor section 220 configuring the object detection section, a measurement range is broad so that influence of optical conditions such as illumination in a shop or a warehouse can be reduced. Since the system configuration is simple, installation or maintenance of the system can be made relatively easy even in an all-hours shop where customers come and go heavily or the like.

By installing the sensor section 220 on the side of the opening on the shelf front 4 side where the merchandise take-out and put-back region 6 of the merchandise display rack 1 is present, it is made possible to form the detection region (the effective detection region 212) for detecting the object 3 on the opening side. Thereby, it is made possible to examine merchandise to which customers pay attention more accurately by detecting the merchandise as the object 3 when customers have picked up the merchandise.

By providing the object detection section on the upper part or the lower part of the merchandise display rack 1, it is made possible to form the detection region (effective detection region 212) for detecting the object 3 from the sensor section 220 downwardly or upwardly. Thereby, even if two or more or a plurality of customers approach the merchandise 2 in front of the merchandise display rack 1 simultaneously, one customer does not configure a blind spot to another customer and the plurality of customers can be detected simultaneously.

It should be noted that the present invention is not limited to the embodiment as it is, and it may be embodied in an implementation stage while constituent elements are modified without departing from the gist of the present invention.

For example, in the embodiment, the present invention has been applied to the article management system which performs management of articles, such as merchandise or a sample in a shop such as a retail outlet, but it is not limited to this embodiment. The present invention can be applied to an article management system managing articles such as parts or members in a warehouse or the like.

In the embodiment, the present invention has been applied to the vertical-type merchandise display rack having shelves for displaying merchandise arranged vertically but it is not limited to this example and the present invention can be applied to a merchandise display stand or a wagon such as a flat base on which a plurality of merchandise is displayed approximately horizontally in a sectioned manner.

Besides, various inventions can be configured by proper combinations of a plurality of constituent elements disclosed in the embodiment. For example, some constituent elements can be removed from all the constituent elements disclosed in the embodiment. Further, constituent elements included in different embodiments can be combined properly.

What is claimed is:

1. An article management system comprising:
an article placement position storage section which stores article identification information about a plurality of articles and article position information showing sections on which the articles are placed in association with each other;
an object detection section which measures a object positioned inside the section or outside the section to output object position information; and
an article specification section which compares object position information detected by the object detection section and the article position information with each other and, when the object position information is included within the section shown by the article position information, specifies an article relating to the article identification information stored in association with the article position information.

2. The article management system according to claim 1, further comprising:
an effective region storage section which stores region information showing an effective region detected by the object detection section, wherein
the object position information output by the object detection section and the region information are compared with each other based upon the region information stored in the effective region storage section, and when the object position information detected by the object detection section is included in a region of the region information, the object position information is sent to the article specification section.

3. The article management system according to claim 1, wherein
the object detection section comprises
a projection section which emits projection light or acoustic wave,
a detection section which detects reflected light or acoustic wave reflected by the object, and
an object position calculation section which calculates object position information showing a position of the object based upon a difference between a time at which the projection section emits projection light or acoustic wave and a time at which the detection section detects light or acoustic wave reflected.

4. The article management system according to claim 1, wherein
the object detection section comprises
a projection section which emits projection light,
a detection section which detects reflected light reflected by the object, and
an object position calculation section which calculates object position information showing a position of the object based upon a difference between a time at which the projection section emits projection light and a time at which the detection section detects reflected light reflected.

5. The article management system according to claim 1, wherein
the object detection section comprises
a projection section which emits projection light or acoustic wave,
a detection section which detects reflected light or acoustic wave reflected by the object,
a reflecting section which reflects projection light or acoustic wave emitted from the projection section in a predetermined direction and reflects reflected light or acoustic wave reflected by the object in a direction of the detection section,
a rotary body which rotates the projection section, the detection section, and the reflecting section together, and
an object position calculation section which calculates object position information showing a position of the object based upon a difference between a time at which the projection section emits projection light or acoustic wave and a time at which the detection section detects light or sound wave reflected.

6. The article management system according to claim 1, wherein
the object detection section comprises
a projection section which emits projection light,
a detection section which detects reflected light reflected by the object,
a reflecting section which reflects projection light emitted form the projection section in a predetermined direction and reflects reflected light reflected by the object in a direction of the detection section,
a rotary body which rotates the projection section, the detection section, and the reflecting section together, and
an object position calculation section which calculates object position information showing a position of the object based upon a difference between a time at which the projection section emits projection light and a time at which the detection section detects light reflected.

7. The article management system according to claim 1, wherein
the object detection section is installed on a placement part on which an article is placed and an detection region thereof includes a region of an opening of the placement part.

8. The article management system according to claim 7, wherein
the object detection section is installed corresponding to each of a plurality of shelves on which an article is placed and a detection region of each object detection section includes a region of an opening of each shelf.

9. The article management system according to claim 7, wherein
the object detection section is installed at each of at least one portion of an upper part of the placement part.

10. The article management system according to claim 7, wherein
the object detection section is installed at each of at least one portion of a lower part of the placement part.

11. The article management system according to claim 7, wherein
the object detection section is installed at each of at least one portion of a side part of the placement part.

12. An information processing apparatus comprising:
an article placement position storage section which stores article identification information about a plurality of articles and article position information showing sections on which the articles are placed in association with each other;
an object position acquiring section which acquires position information of an object from an object detection section; and
an article specification section which compares object position information acquired by the object position acquiring section and the object position information with each other, and when the object position information is included in the article position information, specifies an article relating to the article identification information stored in association with the article position information.

13. The information processing apparatus according to claim 12, further comprising
an effective region storage section which stores region information showing an effective region detected by the object detection section, wherein
the object position information output by the object detection section and the region information are compared with each other based upon the region information stored in the effective region storage section, and when the object position information detected by the object detection section is included in the region information, the object position information is sent to the article specification section.

14. An article management system comprising:
an article placement part where a plurality of articles is placed in a predetermined section;
an article placement position storage section which stores article identification information about the plurality of articles and article position information showing a section where the plurality of articles is placed in association with each other;
an object detection section which measures a position of an object to output object position information; and
an article specification section which compares object position information detected by the object detection section and the article position information with each other and, when the object position information is included within the section shown by the article position information, specifies an article relating to the article identification information stored in association with the article position information.

15. The article management system according to claim 14, further comprising:
an effective region storage section which stores region information showing an effective region detected by the object detection section, wherein
the object position information output by the object detection section and the region information are compared with each other based upon the region information stored in the effective region storage section, and when the object position information detected by the object detection section is included in the region information, the object position information is sent to the article specification section.

16. The article management system according to claim 14, wherein
the article placement part has an opening through which an article can be taken in and out, and
the object detection section is configured such that a region where a position of an object can be measured includes a region of the opening.

17. The article management system according to claim 14, wherein
the article placement part is provided with a plurality of shelves having an opening through which an article can be taken in and out, and
the object detection section is installed for each shelf and each object detection section is configured such that a region where a position of an object can be measured includes a region of the opening.

18. The article management system according to claim 14, wherein
the object detection section is installed at least one portion of an upper part of the placement part and is configured such that a region where a position of an object can be measured includes a region of an opening of the placement part.

19. The article management system according to claim 14, wherein
the object detection section is installed at least one portion of a side part of the placement part and is configured such that a region where a position of an object can be measured includes a region of an opening of the placement part.

20. The article management system according to claim 14, wherein
the object detection section is installed at least one portion of an upper part of the placement part and is configured such that a region where a position of an object can be measured includes a region of an opening of the placement part.
